(19) United States
(12) Patent Application Publication
(10) Pub. No.: US 2022/0173949 A1
(43) Pub. Date: Jun. 2, 2022

(54) TERMINAL AND TRANSMISSION METHOD

(71) Applicant: NTT DOCOMO, INC., Tokyo (JP)

(72) Inventors: Juan Liu, Beijing (CN); Wenjia Liu, Beijing (CN); Xin Wang, Beijing (CN); Xiaolin Hou, Beijing (CN); Anxin Li, Beijing (CN); Lan Chen, Beijing (CN)

(73) Assignee: NTT DOCOMO, INC., Tokyo (JP)

(21) Appl. No.: 17/602,658

(22) PCT Filed: May 10, 2019
(86) PCT No.: PCT/CN2019/086473

§ 371 Date: Oct. 8, 2021

(51) Int. Cl. H04L 27/26

(52) U.S. Cl. CPC H04L 27/26025; H04L 27/2636; H04L 27/2628

(57) ABSTRACT

The present disclosure provides a terminal and a transmission method, the terminal including: a processing unit configured to perform Orthogonal Frequency Division Multiplexing (OFDM) processing on a first symbol sequence to obtain a second symbol sequence, and perform Faster than Nyquist (FTN) modulation on the second symbol sequence in time domain to obtain a third symbol sequence; and a transmitting unit configured to transmit the FTN-modulated third symbol sequence.

### TECHNICAL FIELD

The present disclosure relates to a field of wireless communication, and more particularly to a terminal and a transmission method.

### BACKGROUND

In a current wireless communication system, an Orthogonal Frequency Division Multiplexing (OFDM) technology may be used to modulate symbol sequences to be transmitted to achieve multi-carrier transmission. In addition, in order to improve spectrum efficiency of multi-carrier transmission waveforms, it is proposed to add Faster-Than-Nyquist (FTN) sampling during the process of OFDM modulation.

For example, FTN sampling may be performed on data of subcarriers in the frequency domain to compress the subcarriers in the frequency domain. However, performing FTN sampling in the frequency domain has limited improvement in spectrum efficiency, and is not suitable for terminal devices that have limited transmission power.

In addition, it is also proposed to add FTN sampling of subcarrier data in the time domain during the process of OFDM modulation, so as to compress the symbol size in the time domain, increase the transmission speed, and improve the spectrum efficiency. Since respective subcarriers are spread in the frequency domain after FTN sampling, they are no longer orthogonal to each other and cannot be directly used for the subsequent operations of OFDM modulation. Therefore, in the prior art, it is necessary to set a mapping unit for FTN sampling to adjust the output results of FTN sampling, for which the system design is complicated.

### SUMMARY OF THE DISCLOSURE

According to an aspect of the present disclosure, a terminal is provided, comprising: a processing unit configured to perform Orthogonal Frequency Division Multiplexing (OFDM) processing on a first symbol sequence to obtain a second symbol sequence, and perform Faster Than Nyquist (FTN) modulation on the second symbol sequence in time domain to obtain a third symbol sequence; and a transmitting unit configured to transmit the FTN-modulated third symbol sequence.

According to an example of the present disclosure, the terminal further comprises a receiving unit configured to receive scheduling information, wherein the scheduling information is used to schedule the terminal on a system bandwidth of a communication system, wherein the transmitting unit transmits the FTN-modulated third symbol sequence according to the scheduling information.

According to an example of the present disclosure, the processing unit is further configured to perform Discrete Fourier Transform (DFT)-based precoding on an initial symbol sequence to obtain the first symbol sequence.

According to an example of the present disclosure, the OFDM processing at least includes performing subcarrier mapping on the first symbol sequence, and performing Inverse Fast Fourier Transform (IFFT) on the mapped first symbol sequence; the FTN modulation includes performing up-sampling and pulse shaping on the second symbol sequence, and a relationship between a sampling factor of the up-sampling and a sampling rate of the pulse shaping is determined according to a relationship between a size of the DFT and a size of the IFFT.

According to an example of the present disclosure, the processing unit performs the subcarrier mapping on the first symbol sequence in a centralized mapping manner.

According to an example of the present disclosure, when performing the subcarrier mapping, the processing unit maps the first symbol sequence to a low frequency region to perform the IFFT.

According to an example of the present disclosure, the terminal further comprises a receiving unit configured to receive information about a compression factor of the FTN modulation, wherein the compression factor indicates a proportional relationship between the sampling factor of the up-sampling and the sampling rate of the pulse shaping.

According to another aspect of the present disclosure, a transmission method is provided, comprising: performing Orthogonal Frequency Division Multiplexing (OFDM) processing on a first symbol sequence to obtain a second symbol sequence, and performing Faster Than Nyquist (FTN) modulation on the second symbol sequence in a time domain to obtain a third symbol sequence; and transmitting the FTN-modulated third symbol sequence.

According to an example of the present disclosure, the transmission method is performed by a terminal, and the transmission method further comprises: receiving scheduling information, wherein the scheduling information is used to schedule the terminal on a system bandwidth of a communication system, wherein the FTN-modulated third symbol sequence is transmitted according to the scheduling information.

According to an example of the present disclosure, the transmission method further comprises performing Discrete Fourier Transform (DFT)-based precoding on an initial symbol sequence to obtain the first symbol sequence.

According to an example of the present disclosure, in the method, the OFDM processing at least includes performing subcarrier mapping on the first symbol sequence, and performing Inverse Fast Fourier Transform (IFFT) on the mapped first symbol sequence; the FTN modulation includes performing up-sampling and pulse shaping on the second symbol sequence, and a relationship between a sampling factor of the up-sampling and a sampling rate of the pulse shaping is determined according to a relationship between a size of the DFT and a size of the IFFT.

According to an example of the present disclosure, in the method, the subcarrier mapping is performed on the first symbol sequence in a centralized mapping manner.

According to an example of the present disclosure, in the method, when performing the subcarrier mapping, the processing unit maps the first symbol sequence to a low frequency region to perform the IFFT.

According to an example of the present disclosure, the method further comprises receiving information about a compression factor of the FTN modulation, wherein the compression factor indicates a proportional relationship between the sampling factor of the up-sampling and the sampling rate of the pulse shaping.

### BRIEF DESCRIPTION OF THE DRAWINGS

The above and other objectives, features, and advantages of the present disclosure will become more obvious with a more detailed description of embodiments of the present disclosure in conjunction with accompanying drawings. The accompanying drawings are used to provide a further understanding of the embodiments of the present disclosure, constitute a part of the specification, explain the present disclosure together with the embodiments of the present disclosure, but do not constitute a limitation to the present disclosure. In the drawings, like reference numerals generally denote like components or steps.

FIG. 1 is a schematic diagram showing an exemplary situation where FTN is added to OFDM modulation.

FIG. 2 is a flowchart showing a transmission method according to an embodiment of the present disclosure.

FIG. 3 is a schematic diagram showing subcarrier mapping according to an embodiment of the present disclosure.

FIG. 4 is a schematic diagram showing FTN modulation according to an embodiment of the present disclosure.

FIG. 5 is a schematic diagram showing FTN modulation in the time domain according to an embodiment of the present disclosure.

FIG. 6 is a schematic diagram showing scheduling of terminals according to an embodiment of the present disclosure.

FIG. 7 is a schematic structural diagram showing a terminal according to an embodiment of the present disclosure.

FIG. 8 is a schematic structural diagram showing a base station according to an embodiment of the present disclosure.

FIG. 9 is a schematic diagram showing a hardware structure of a device according to the embodiments of the present disclosure.

### DESCRIPTION OF THE EMBODIMENTS

In order to make objectives, technical solutions, and advantages of the present disclosure more obvious, exemplary embodiments according to the present disclosure will be described in detail below with reference to the accompanying drawings. Like reference numerals denote like elements throughout the accompanying drawings. It should be appreciated that the embodiments described herein are merely illustrative and should not be construed as limiting the scope of the present disclosure. In addition, a transmitter described herein may be a transmitter on the base station side, or a transmitter on the terminal side, and the terminal may include various types of terminals, such as a User Equipment (UE), a mobile terminal (or referred to as a mobile station) or a fixed terminal.

First, an exemplary situation of adding FTN to traditional OFDM modulation will be described with reference to FIG. 1. As shown in FIG. 1, a conventional OFDM modulation unit 100 may include a serial/parallel (S/P) converter 110, an Inverse Fast Fourier Transform (IFFT) module 130, a cyclic prefix (CP) inserter 140, and a parallel/serial (P/S) converter 150. According to a currently proposed method for improving spectrum efficiency, FTN sampling may be inserted between serial/parallel (S/P) conversion and Inverse Fast Fourier transform (IFFT) when performing OFDM modulation. Specifically, as shown in FIG. 1, after serial/parallel conversion of data by the serial/parallel (S/P) converter, data of each subcarrier may be input to a respective FTN mapper 120-1 to 120-n for FTN sampling in the time domain. Since data of respective subcarriers after FTN sampling is not orthogonal, in the example shown in FIG. 1, FTN mappers 120-1 to 120-n are also used to map the respective subcarrier data after FTN sampling to obtain subcarrier data orthogonal in frequency, and the mapped subcarrier data is input to the IFFT module 130 for subsequent operations of OFDM modulation. This makes the system design complicated and cumbersome to operate.

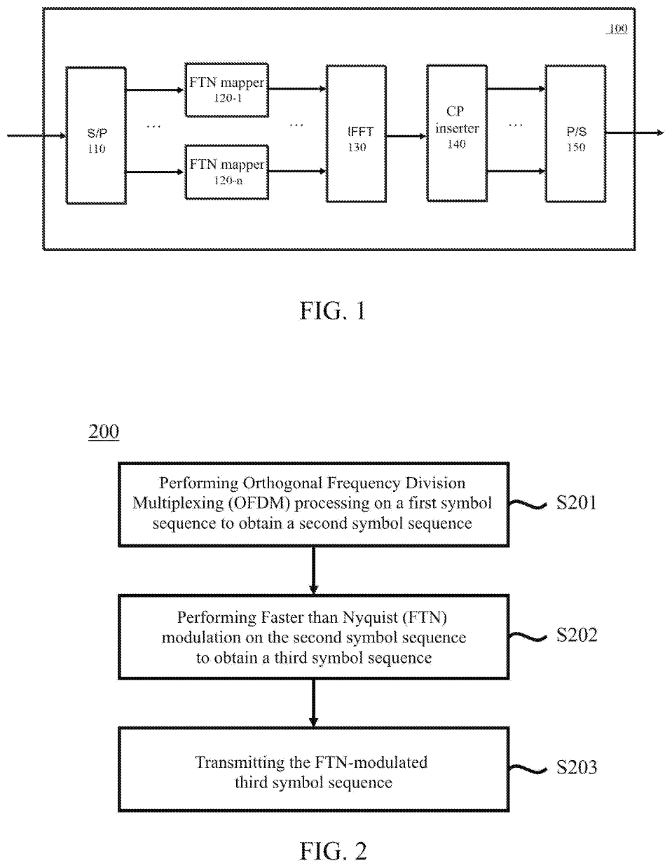

In order to solve the above-mentioned problems, the present disclosure proposes a transmission method and a corresponding device to simplify operations as well as improve spectrum efficiency. A transmission method according to an embodiment of the present disclosure will be described below with reference to FIG. 2. FIG. 2 is a flowchart of a transmission method 200 according to an embodiment of the present disclosure.

As shown in FIG. 2, in step S201, Orthogonal Frequency Division Multiplexing (OFDM) processing is performed on a first symbol sequence to obtain a second symbol sequence. According to an example of the present disclosure, the first symbol sequence may be an initial symbol sequence to be transmitted. The initial symbol sequence may include information to be transmitted via each subcarrier.

In addition, since the Peak-to-Average Power Ratio (PAPR) of a OFDM-processed waveform is relatively high, according to another example of the present disclosure, the initial symbol sequence to be transmitted is subjected to Discrete Fourier Transform (DFT)-based precoding before the OFDM processing, and the obtained precoded symbol sequence is used as the first symbol sequence. In this case, the OFDM processing may at least include performing subcarrier mapping on the first symbol sequence, and performing Inverse Fast Fourier Transform (IFFT) on the mapped first symbol sequence. Specifically, during the subcarrier mapping, the DFT-precoded first symbol sequence that includes information to be transmitted via each subcarrier may be mapped to a wider frequency band (for example, a system bandwidth) used by the IFFT to facilitate subsequent IFFT operations.

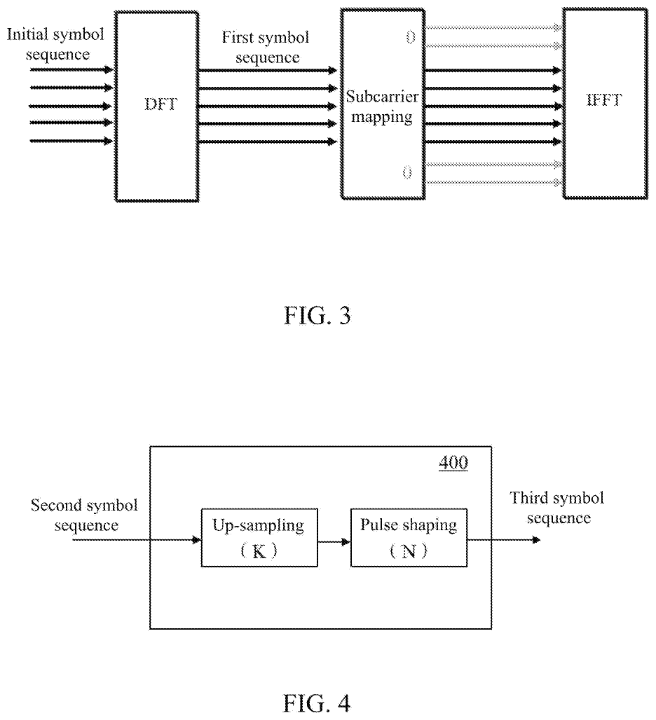

FIG. 3 is a schematic diagram showing subcarrier mapping according to an embodiment of the present disclosure. As shown by the black arrows in FIG. 3, after DFT-based precoding of the initial symbol sequence to be transmitted, the obtained first symbol sequence may be centrally mapped to a specific region of the frequency band used by the IFFT. The specific region may be a low frequency region, a middle frequency region, or a high frequency region of the frequency band used by the IFFT. In addition, as shown by the gray arrows in FIG. 3, during the subcarrier mapping, zeros may be filled in regions of the frequency band used by the IFFT to which the first symbol sequence is not mapped.

In the above example shown in FIG. 3, the description is made in the manner of performing centralized mapping on the DFT-based precoded first symbol sequence. Alternatively, according to another example of the present disclosure, it is also possible to perform subcarrier mapping on the DFT-based precoded first symbol sequence in a distributed mapping manner. For example, the first symbol sequence may be mapped at a specific interval in the entire frequency band used by the IFFT.

Returning to FIG. 2, after the OFDM processing, in step S202, Faster Than Nyquist (FTN) modulation is performed on the second symbol sequence in the time domain to obtain a third symbol sequence. According to an example of the present disclosure, the FTN modulation may include performing up-sampling and pulse shaping on the OFDM-processed second symbol sequence.

FIG. 4 is a schematic diagram showing FTN modulation 400 according to an embodiment of the present disclosure. As shown in FIG. 4, in the FTN modulation 400, the second symbol sequence may be up-sampled firstly. For example, the second symbol sequence may be up-sampled by using an up-sampling factor K, where the up-sampling factor K represents a symbol interval in the up-sampled sequence. By way of example, suppose that the symbol interval in the sequence is 1 before up-sampling with a sampling factor of K, then during the up-sampling process, (K-1) zeros are inserted between symbols in the sequence by interpolation, so that the symbol interval in the up-sampled sequence becomes K. That is, after being up-sampled with the sampling factor of K, the symbol interval in the sequence is K.

Then, pulse shaping may be performed by a pulse shaping filter with a sampling rate of N. Effect of the FTN modulation may be expressed by a compression factor α, where the compression factor α=K/N. It can be seen that when K<N, the compression factor α<1, and FTN transmission may be realized at this time.

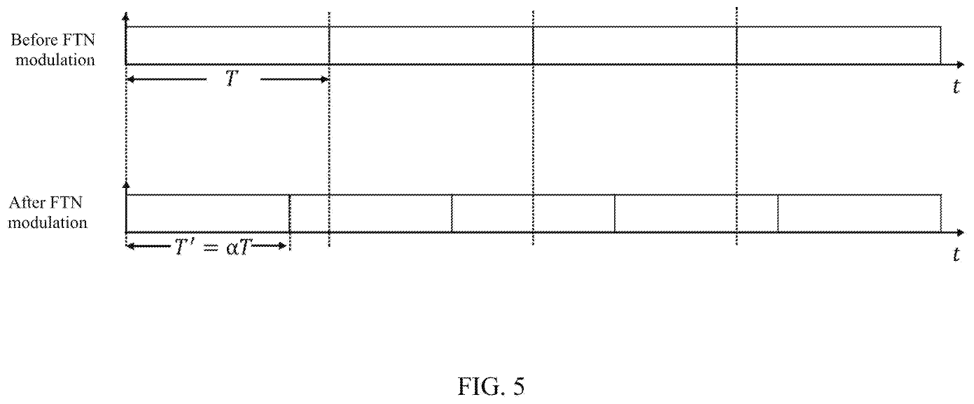

FIG. 5 is a schematic diagram showing FTN modulation in the time domain according to an embodiment of the present disclosure. As shown in FIG. 5, before FTN modulation, the interval between each symbol is T, and after FTN modulation with a compression factor less than 1, the interval between each symbol is compressed to T′=αT.

In the method according to the present disclosure, by performing OFDM processing and then FTN modulation in the time domain on signals to be transmitted, there is no need to set up a mapper to convert signals generated by FTN that are not orthogonal in frequency to orthogonal signals, thereby simplifying the operations and at the same time improving the spectrum efficiency.

In addition, as described in step S201, according to an example of the present disclosure, Discrete Fourier Transform (DFT)-based precoding may be performed on the initial symbol sequence to be transmitted before OFDM processing, and the obtained precoded symbol sequence is used as the first symbol sequence, thereby improving the PAPR of waveforms. In this case, a relationship between the sampling factor and the sampling rate of pulse shaping may be determined according to a relationship between a size of the DFT and a size of the IFFT. In an embodiment according to the present disclosure, the size of the DFT may be a length of the symbol sequence that can be processed in one DFT operation, and similarly, the size of the IFFT may be a length of the symbol sequence that can be processed in one IFFT operation. That is, the compression factor α of the FTN may be determined according to the relationship between the size of the DFT and the size of the IFFT. And the sampling factor K may be adjusted according to the determined compression factor α.

For example, the compression factor α of the FTN may be determined according to a proportional relationship between the size of the DFT and the size of the IFFT. More specifically, in the subcarrier mapping process, when the DFT precoded first symbol sequence is mapped to the low frequency region used by the IFFT in a centralized mapping manner, the compression factor α of the FTN may be determined based on the following formula (1):

$$α = \frac{K}{N} = \frac{{N}_{1}}{{N}_{2}} \qquad ( 1 )$$

where N₁ is the size of the DFT and N₂ is the size of the IFFT.

At this time, spectrum efficiency can be improved to the greatest extent under the premise of improving the peak-to-average ratio, and an improvement rate SE of the spectrum efficiency is expressed by the following formula (2):

$$S E = \frac{1 - α}{α} \times 100 \% \qquad ( 2 )$$

In the above case where the DFT precoded first symbol sequence is mapped to the low frequency region used by the IFFT in a centralized mapping manner, it is described by taken the example that the compression factor α of the FTN is equal to the ratio between the size of the DFT and the size of the IFFT. According to other examples of the present disclosure, the compression factor α of the FTN may also be determined according to other relationships between the size of the DFT and the size of the IFFT. For example, an offset may be added to the formula (1) for adjustment as needed.

In addition, when the transmission method shown in FIG. 2 is performed by a terminal, a base station may configure a compression factor of FTN modulation used by the terminal. In this case, the method shown in FIG. 2 may further include receiving information about the compression factor of the FTN modulation, where the compression factor indicates the relationship between the sampling factor of the up-sampling and the sampling rate of the pulse shaping. For example, the base station may determine the compression factor of the FTN modulation used by the terminal according to a size of DFT and IFFT to be performed by the terminal, and transmit relevant information to the terminal.

In addition, a device that performs the transmission method shown in FIG. 2 may also determine a compression factor of FTN modulation by itself according to a size of DFT and IFFT, and transmit it to a receiving device, so that the receiving device may decode received data according to the compression factor of the FTN modulation.

Signaling used to transmit information related to a may be explicit or implicit. For example, a transmitting device may directly include the determined value of compression factor α in the above signaling for transmission, may include the up-sampling factor K and the pulse shaping sampling rate N determined in the FTN modulation in the above signaling for transmission, and may also include values of the DFT size N₁ and the IFFT size N₂ used in signal modulation in the above signaling for transmission. In addition, the information related to a may be transmitted through higher layer signaling, or physical layer signaling and the like.

Returning to FIG. 2, in step S203, the FTN-modulated third symbol sequence is transmitted. According to an example of the present disclosure, in a wireless communication system to which this method is applied, a base station may not divide system resources into physical resource blocks and perform scheduling based on the physical resource blocks as in existing communication systems, but can perform scheduling on the bandwidth of the communication system, thereby avoiding the loss of spectrum efficiency caused by increased guard intervals, and ensuring performance advantages of different terminals.

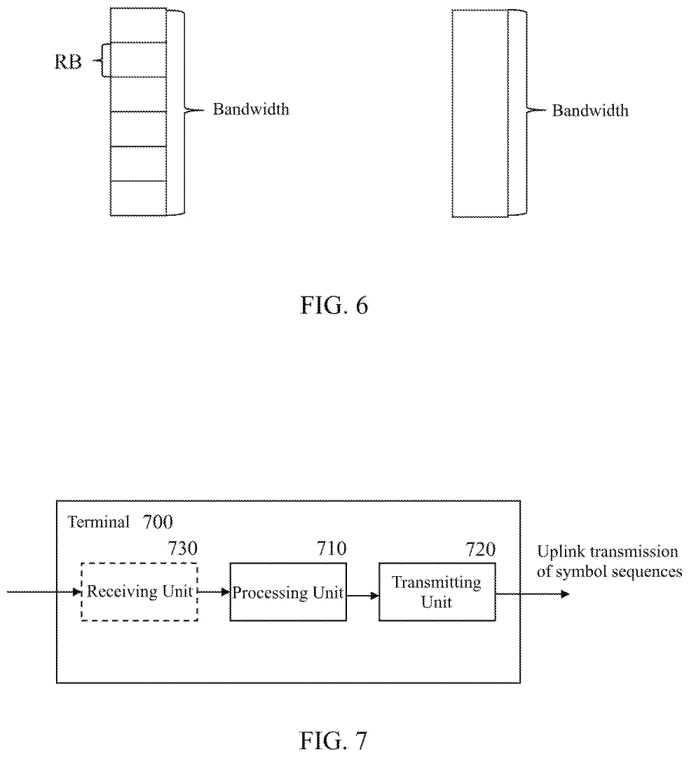

FIG. 6 is a schematic diagram showing scheduling of terminals according to an embodiment of the present disclosure. As shown on the left side of FIG. 6, in a traditional communication system, system resources are divided into physical resource blocks, and a base station schedules terminals based on the physical resource blocks, and different resource blocks on the bandwidth may be used for different terminals. However, as shown on the right side of FIG. 6, according to an embodiment of the present disclosure, during subcarrier mapping, a first symbol sequence of a terminal that is subjected to DFT may be mapped to the entire system frequency band, so that the base station can schedule the terminal in the unit of the entire system frequency band.

Next, a terminal 700 according to an embodiment of the present disclosure will be described with reference to FIG. 7. FIG. 7 is a schematic structural diagram showing a terminal 700 according to an embodiment of the present disclosure.

As shown in FIG. 7, a processing unit 710 performs Orthogonal Frequency Division Multiplexing (OFDM) processing on a first symbol sequence to obtain a second symbol sequence. According to an example of the present disclosure, the first symbol sequence may be an initial symbol sequence to be transmitted. The initial symbol sequence may include information to be transmitted via each subcarrier.

In addition, since the Peak-to-Average Power Ratio (PAPR) of a OFDM-processed waveform is relatively high, according to another example of the present disclosure, the processing unit 710 performs Discrete Fourier Transform (DFT)-based precoding on the initial symbol sequence to be transmitted before the OFDM processing, and the obtained precoded symbol sequence is used as the first symbol sequence. In this case, the OFDM processing may at least include performing subcarrier mapping on the first symbol sequence, and performing Inverse Fast Fourier Transform (IFFT) on the mapped first symbol sequence. Specifically, during the subcarrier mapping, the processing unit 710 may map the DFT-precoded first symbol sequence that includes information to be transmitted via each subcarrier to a wider frequency band (for example, a system bandwidth) used by the IFFT to facilitate subsequent IFFT operations. After DFT-based precoding of the initial symbol sequence to be transmitted, the processing unit 710 may centrally map the obtained first symbol sequence to a specific region of the frequency band used by the IFFT. The specific region may be a low frequency region, a middle frequency region, or a high frequency region of the frequency band used by the IFFT. In addition, the processing unit 710 may, during the subcarrier mapping, fill zeros in regions of the frequency band used by the IFFT to which the first symbol sequence is not mapped.

Alternatively, according to another example of the present disclosure, the processing unit 710 may also perform subcarrier mapping on the DFT-based precoded first symbol sequence in a distributed mapping manner. For example, the first symbol sequence may be mapped at a specific interval in the entire frequency band used by the IFFT.

After the OFDM processing, the processing unit 710 performs Faster Than Nyquist (FTN) modulation on the second symbol sequence in the time domain to obtain a third symbol sequence. According to an example of the present disclosure, the FTN modulation may include performing up-sampling and pulse shaping on the OFDM-processed second symbol sequence.

According to an example of the present disclosure, the processing unit 710 may up-sample the second symbol sequence firstly. For example, the processing unit 710 may up-sample the second symbol sequence by using an up-sampling factor K, where the up-sampling factor K represents a symbol interval in the up-sampled sequence. By way of example, suppose that the symbol interval in the sequence is 1 before up-sampling with a sampling factor of K, then during the up-sampling process, the processing unit 710 inserts (K-1) zeros between symbols in the sequence by interpolation, so that the symbol interval in the up-sampled sequence becomes K. That is, after the up-sampling with the sampling factor of K, the symbol interval in the sequence is K.

Then, the processing unit 710 performs pulse shaping on the symbol sequence by a pulse shaping filter with a sampling rate of N. Effect of the FTN modulation may be expressed by a compression factor α, where the compression factor α=K/N. It can be seen that when K<N, the compression factor α<1, and FTN transmission may be realized at this time. Suppose that the interval between each symbol before FTN modulation by the processing unit 710 is T, and after the processing unit 710 performs FTN modulation with a compression factor less than 1, the interval between each symbol is compressed to T′=αT.

With the terminal according to the present disclosure, the processing unit 710 performs OFDM processing and then FTN modulation in the time domain on signals to be transmitted, there is no need to set up a mapper to convert signals generated by FTN that are not orthogonal in frequency to orthogonal signals, thereby simplifying the operations and at the same time improving the spectrum efficiency.

In addition, as described above, according to an example of the present disclosure, the processing unit 710 may perform Discrete Fourier Transform (DFT)-based precoding on the initial symbol sequence to be transmitted before OFDM processing, and the obtained precoded symbol sequence is used as the first symbol sequence, thereby improving PAPR of waveforms. In this case, the processing unit 710 may determine a relationship between the sampling factor and the sampling rate of pulse shaping according to a relationship between a size of the DFT and a size of the IFFT. In an embodiment according to the present disclosure, the size of the DFT may be a length of the symbol sequence that can be processed in one DFT operation, and similarly, the size of the IFFT may be a length of the symbol sequence that can be processed in one IFFT operation. That is, the processing unit 710 may determine the compression factor α of the FTN according to the relationship between the size of the DFT and the size of the IFFT. And the processing unit 710 may adjust the sampling factor K according to the determined compression factor α.

For example, the compression factor α of the FTN may be determined according to a proportional relationship between the size of the DFT and the size of the IFFT. More specifically, in the subcarrier mapping process, when the DFT precoded first symbol sequence is mapped to the low frequency region used by the IFFT in a centralized mapping manner, the compression factor α of the FTN may be determined based on the above formula (1). At this time, spectrum efficiency can be improved to the greatest extent under the premise of improving the peak-to-average ratio.

In the case where the processing unit 710 maps the DFT precoded first symbol sequence to the low frequency region used by the IFFT in a centralized mapping manner, it is described by taken the example that the compression factor α of the FTN is equal to the ratio between the size of the DFT and the size of the IFFT. According to other examples of the present disclosure, the processing unit 710 may also determine the compression factor α of the FTN according to other relationships between the size of the DFT and the size of the IFFT. For example, an offset may be added to the formula (1) for adjustment as needed.

In addition, a base station may configure a compression factor of FTN modulation used by the terminal 700. In this case, the terminal 700 may further include a receiving unit 730 for receiving information about the compression factor of the FTN modulation, where the compression factor indicates the relationship between the sampling factor of the up-sampling and the sampling rate of the pulse shaping. For example, a base station that has established a connection with the terminal 700 may determine the compression factor of the FTN modulation used by the terminal 700 according to a size of DFT and IFFT to be performed by the terminal 700, and transmit relevant information to the terminal 700.

In addition, the processing unit 710 of the terminal 700 may also determine a compression factor of FTN modulation by itself according to a size of DFT and IFFT, which is then transmitted by the transmitting unit 720 to a receiving device to facilitate the decoding of received data performed by the receiving device according to the compression factor of the FTN modulation.

Signaling used to transmit information related to a may be explicit or implicit. For example, the transmitting unit 720 may directly include a value of the compression factor α determined by the processing unit 710 in the above signaling for transmission, may include the up-sampling factor K and the pulse shaping sampling rate N determined by the processing unit 710 in the FTN modulation in the above signaling for transmission, and may also include values of the DFT size N₁ and the IFFT size N₂ used by the processing unit 710 in signal modulation in the above signaling for transmission. In addition, the information related to a may be transmitted through higher layer signaling, or physical layer signaling and the like.

The transmitting unit 720 transmits the FTN-modulated third symbol sequence. According to an example of the present disclosure, in a wireless communication system including the terminal 700, a base station may not divide system resources into physical resource blocks and perform scheduling based on the physical resource blocks as in existing communication systems, but can modulate on the bandwidth of the communication system, thereby avoiding the loss of spectrum efficiency caused by increased guard intervals, and ensuring performance advantages of different terminals. According to an embodiment of the present disclosure, during subcarrier mapping, the processing unit 710 of the terminal 700 may map a first symbol sequence that is subjected to DFT to the entire system frequency band, so that the base station that has established a connection with the terminal 700 can schedule the terminal 700 in the unit of the entire system frequency band.

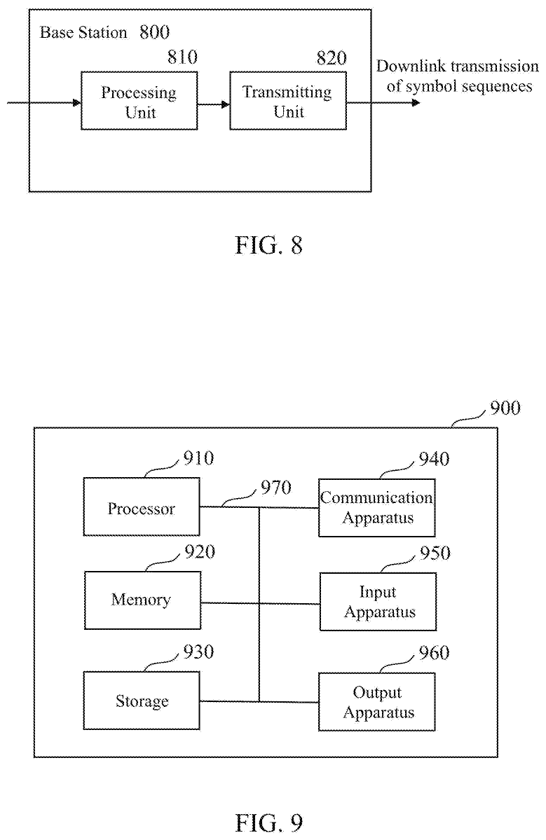

The terminal according to an embodiment of the present disclosure is described above with reference to FIG. 7. In addition, the method shown in FIG. 2 may also be used in a base station. Next, a base station 800 according to an embodiment of the present disclosure will be described with reference to FIG. 8. FIG. 8 is a schematic structural diagram showing a base station 800 according to an embodiment of the present disclosure. FIG. 8 shows a processing unit 810 and a transmitting unit 820 of the base station 800.

In transmission of the base station 800, most of its operations are similar to those performed by the above-mentioned terminal, which are only briefly summarized below, and specific descriptions are not repeated.

Similarly to the terminal, a processing unit 810 of the base station 800 performs Orthogonal Frequency Division Multiplexing (OFDM) processing on a first symbol sequence to obtain a second symbol sequence. Moreover, according to an example of the present disclosure, the processing unit 810 performs Discrete Fourier Transform (DFT)-based precoding on an initial symbol sequence to be transmitted before the OFDM processing to obtain the first symbol sequence.

The OFDM processing performed by the processing unit 810 may include at least centralized or distributed subcarrier mapping on the first symbol sequence, and Inverse Fast Fourier Transform (IFFT) on the mapped first symbol sequence. After the processing OFDM, the processing unit 810 performs Faster Than Nyquist (FTN) modulation on the second symbol sequence in the time domain to obtain a third symbol sequence. Similarly, the FTN modulation may include performing up-sampling and pulse shaping on the OFDM-processed second symbol sequence. The processing unit 810 may up-sample the second symbol sequence by using an up-sampling factor K, and performs pulse shaping on the symbol sequence by a pulse shaping filter with a sampling rate of N. The effect of FTN may be expressed by a compression factor α=K/N.

The processing unit 810 may determine a compression factor α of the FTN according to a relationship between the size of the DFT and the size of the IFFT. The specific determination method is the same as the operations performed by the terminal as described above, and will not be repeatedly described herein.

The processing unit 810 of the base station 800 may determine the compression factor of the FTN modulation according to the sizes of the DFT and IFFT, which is then transmitted by the transmitting unit 820 to a receiving device to facilitate the decoding of received data performed by the receiving device according to the compression factor of the FTN modulation. Signaling used to transmit information related to a may be explicit or implicit. Information related to α may be transmitted through higher layer signaling, or physical layer signaling and the like.

At last, the transmitting unit 820 transmits the FTN-modulated third symbol sequence. According to an example of the present disclosure, the base station 800 may not divide system resources into physical resource blocks and perform scheduling based on the physical resource blocks as in existing communication systems, but can modulate in the unit of the entire system frequency band.

It should be noted that, in the prior art, DFT precoding is generally not applied to downlink transmission. Therefore, when the base station 800 performs the above-mentioned transmission, if the compression factor α is to be determined based on the relationship between the sizes of the DFT and IFFT, DFT precoding of initial symbol sequences must be performed by the processing unit 810.

<Hardware Structure>

In addition, block diagrams used in the description of the above embodiments illustrate blocks in units of functions. These functional blocks (structural blocks) may be implemented in arbitrary combination of hardware and/or software. Furthermore, means for implementing respective functional blocks is not particularly limited. That is, the respective functional blocks may be implemented by one apparatus that is physically and/or logically jointed; or more than two apparatuses that are physically and/or logically separated may be directly and/or indirectly connected (e.g. wired and/or wirelessly), and the respective functional blocks may be implemented by these apparatuses.

For example, a device (such as the base station, the terminal, etc.) in an embodiment of the present disclosure may function as a computer that executes the processes of the wireless communication method of the present disclosure. FIG. 9 is a schematic diagram of a hardware structure of a device 900 (a base station, a terminal) involved in an embodiment of the present disclosure. The above device 900 may be constituted as a computer apparatus that physically comprises a processor 910, a memory 920, a storage 930, a communication apparatus 940, an input apparatus 950, an output apparatus 960, a bus 970 and the like

In addition, in the following description, terms such as “apparatus” may be replaced with circuits, devices, units, and the like. The hardware structure of the user terminal may include one or more of the respective apparatuses shown in the figure, or may not include a part of the apparatuses.

For example, only one processor 910 is illustrated, but there may be multiple processors. Furthermore, processes may be performed by one processor, or processes may be performed by more than one processor simultaneously, sequentially, or with other methods. In addition, the processor 910 may be installed by more than one chip.

Respective functions of any of the device 900 may be implemented, for example, by reading specified software (program) on hardware such as the processor 910 and the memory 920, so that the processor 910 performs computations, controls communication performed by the communication apparatus 940, and controls reading and/or writing of data in the memory 920 and the storage 930.

The processor 910, for example, operates an operating system to control the entire computer. The processor 910 may be constituted by a Central Processing Unit (CPU), which includes interfaces with peripheral apparatuses, a control apparatus, a computing apparatus, a register and the like. For example, the processing unit and the like described above may be implemented by the processor 910.

In addition, the processor 910 reads programs (program codes), software modules and data from the storage 930 and/or the communication apparatus 940 to the memory 920, and execute various processes according to them. As for the program, a program causing computers to execute at least a part of the operations described in the above embodiments may be employed. For example, the processing unit of the terminal 700 or the base station 800 may be implemented by a control program stored in the memory 920 and operated by the processor 910, and other functional blocks may also be implemented similarly.

The memory 920 is a computer-readable recording medium, and may be constituted, for example, by at least one of a Read Only Memory (ROM), an Erasable Programmable ROM (EPROM), an Electrically EPROM (EEPROM), a Random Access Memory (RAM) and other appropriate storage media. The memory 920 may also be referred to as a register, a cache, a main memory (a main storage apparatus) and the like. The memory 920 may store executable programs (program codes), software modules and the like for implementing a method involved in an embodiment of the present disclosure.

The storage 930 is a computer-readable recording medium, and may be constituted, for example, by at least one of a flexible disk, a floppy® disk, a magneto-optical disk (e.g., a Compact Disc ROM (CD-ROM) and the like), a digital versatile disk, a Blu-ray® disk, a removable disk, a hard driver, a smart card, a flash memory device (e.g., a card, a stick and a key driver), a magnetic stripe, a database, a server, and other appropriate storage media. The storage 930 may also be referred to as an auxiliary storage apparatus.

The communication apparatus 940 is a hardware (transceiver device) performing communication between computers via a wired and/or wireless network, and is also referred to as a network device, a network controller, a network card, a communication module and the like, for example. The communication apparatus 940 may include a high-frequency switch, a duplexer, a filter, a frequency synthesizer and the like to implement, for example, Frequency Division Duplex (FDD) and/or Time Division Duplex (TDD). For example, the transmitting unit, the receiving unit and the like described above may be implemented by the communication apparatus 940.

The input apparatus 950 is an input device (e.g., a keyboard, a mouse, a microphone, a switch, a button, a sensor and the like) that receives input from the outside. The output apparatus 960 is an output device (e.g., a display, a speaker, a Light Emitting Diode (LED) light and the like) that performs outputting to the outside. In addition, the input apparatus 850 and the output apparatus 960 may also be an integrated structure (e.g., a touch screen).

Furthermore, the respective apparatuses such as the processor 910 and the memory 920 are connected by the bus 970 that communicates information. The bus 970 may be constituted by a single bus or by different buses between the apparatuses.

Furthermore, the user terminal may comprise hardware such as a microprocessor, a Digital Signal Processor (DSP), an Application Specified Integrated Circuit (ASIC), a Programmable Logic Device (PLD), a Field Programmable Gate Array (FPGA), etc., and the hardware may be used to implement a part of or all of the respective functional blocks. For example, the processor 910 may be installed by at least one of these hardware.

(Variations)

In addition, the terms illustrated in the present specification and/or the terms required for understanding of the present specification may be substituted with terms having the same or similar meaning. For example, a channel and/or a symbol may also be a signal (signaling). Furthermore, the signal may be a message. A reference signal may be abbreviated as an “RS”, and may also be referred to as a pilot, a pilot signal and so on, depending on the standard applied. Furthermore, a component carrier (CC) may also be referred to as a cell, a frequency carrier, a carrier frequency, and the like.

Furthermore, the information, parameters and so on described in this specification may be represented in absolute values or in relative values with respect to specified values, or may be represented by other corresponding information. For example, radio resources may be indicated by specified indexes. Furthermore, formulas and the like using these parameters may be different from those explicitly disclosed in this specification.

The names used for the parameters and the like in this specification are not limited in any respect. For example, since various channels (Physical Uplink Control Channels (PUCCHs), Physical Downlink Control Channels (PDCCHs), etc.) and information elements may be identified by any suitable names, the various names assigned to these various channels and information elements are not limitative in any respect.

The information, signals and the like described in this specification may be represented by using any one of various different technologies. For example, data, instructions, commands, information, signals, bits, symbols, chips, etc. possibly referenced throughout the above description may be represented by voltages, currents, electromagnetic waves, magnetic fields or particles, optical fields or photons, or any combination thereof.

In addition, information, signals and the like may be output from higher layers to lower layers and/or from lower layers to higher layers. Information, signals and the like may be input or output via a plurality of network nodes.

The information, signals and the like that are input or output may be stored in a specific location (for example, in a memory), or may be managed in a control table. The information, signals and the like that are input or output may be overwritten, updated or appended. The information, signals and the like that are output may be deleted. The information, signals and the like that are input may be transmitted to other apparatuses.

Reporting of information is by no means limited to the manners/embodiments described in this specification, and may be implemented by other methods as well. For example, reporting of information may be implemented by using physical layer signaling (for example, downlink control information (DCI), uplink control information (UCI)), higher layer signaling (for example, RRC (Radio Resource Control) signaling, broadcast information (master information blocks (MIBs), system information blocks (SIBs), etc.), MAC (Medium Access Control) signaling), other signals or combinations thereof.

In addition, physical layer signaling may also be referred to as L1/L2 (Layer 1/Layer 2) control information (L1/L2 control signals), L1 control information (L1 control signal) and the like. Furthermore, RRC signaling may also be referred to as RRC messages, for example, RRC connection setup messages, RRC connection reconfiguration messages, and so on. Furthermore, MAC signaling may be reported by using, for example, MAC control elements (MAC CEs).

Furthermore, notification of prescribed information (for example, notification of “being X”) is not limited to being performed explicitly, and may be performed implicitly (for example, by not performing notification of the prescribed information or by notification of other information).

Decision may be performed by a value (0 or 1) represented by 1 bit, or by a true or false value (Boolean value) represented by TRUE or FALSE, or by a numerical comparison (e.g., comparison with a prescribed value).

Software, whether referred to as “software”, “firmware”, “middleware”, “microcode” or “hardware description language”, or called by other names, should be interpreted broadly to mean instructions, instruction sets, code, code segments, program codes, programs, subprograms, software modules, applications, software applications, software packages, routines, subroutines, objects, executable files, execution threads, procedures, functions and so on.

In addition, software, commands, information, etc. may be transmitted and received via a transport medium. For example, when software is transmitted from web pages, servers or other remote sources using wired technologies (coaxial cables, fibers, twisted pairs, Digital Subscriber Lines (DSLs), etc.) and/or wireless technologies (infrared ray, microwave, etc.), these wired technologies and/or wireless technologies are included in the definition of the transport medium.

The terms “system” and “network” used in this specification may be used interchangeably.

In this specification, terms like “Base Station (BS)”, “wireless base station”, “eNB”, “gNB”, “cell”, “sector”, “cell group”, “carrier” and “component carrier” may be used interchangeably. A base station is sometimes referred to as terms such as a fixed station, a NodeB, an eNodeB (eNB), an access point, a transmitting point, a receiving point, a femto cell, a small cell and the like.

A base station is capable of accommodating one or more (for example, three) cells (also referred to as sectors). In the case where the base station accommodates a plurality of cells, the entire coverage area of the base station may be divided into a plurality of smaller areas, and each smaller area may provide communication services by using a base station sub-system (for example, a small base station for indoor use (a Remote Radio Head (RRH)). Terms like “cell” and “sector” refer to a part of or an entirety of the coverage area of a base station and/or a sub-system of the base station that provides communication services in this coverage.

In this specification, terms such as “Mobile Station (MS)”, “user terminal”, “User Equipment (UE)”, and “terminal” may be used interchangeably. The mobile station is sometimes referred by those skilled in the art as a user station, a mobile unit, a user unit, a wireless unit, a remote unit, a mobile device, a wireless device, a wireless communication device, a remote device, a mobile user station, an access terminal, a mobile terminal, a wireless terminal, a remote terminal, a handset, a user agent, a mobile client, a client, or some other appropriate terms.

Furthermore, a wireless base station in this specification may also be replaced with a user terminal. For example, for a structure in which communication between a wireless base station and a user terminal is replaced with communication between a plurality of user terminals (Device-to-Device, D2D), the respective manners/embodiments of the present disclosure may also be applied. At this time, functions provided by the first communication device and the second communication device of the above device 900 may be regarded as functions provided by a user terminal. Furthermore, the words “uplink” and “downlink” may also be replaced with “side”. For example, an uplink channel may be replaced with a side channel.

Also, a user terminal in this specification may be replaced with a wireless base station. At this time, functions provided by the above user terminal may be regarded as functions provided by the first communication device and the second communication device.

In this specification, specific actions configured to be performed by the base station sometimes may be performed by its upper nodes in certain cases. Obviously, in a network composed of one or more network nodes having base stations, various actions performed for communication with terminals may be performed by the base stations, one or more network nodes other than the base stations (for example, Mobility Management Entities (MMEs), Serving-Gateways (S-GWs), etc., may be considered, but not limited thereto)), or combinations thereof.

The respective manners/embodiments described in this specification may be used individually or in combinations, and may also be switched and used during execution. In addition, orders of processes, sequences, flow charts and so on of the respective manners/embodiments described in this specification may be re-ordered as long as there is no inconsistency. For example, although various methods have been described in this specification with various units of steps in exemplary orders, the specific orders as described are by no means limitative.

The manners/embodiments described in this specification may be applied to systems that utilize Long Term Evolution (LTE), Advanced Long Term Evolution (LTE-A, LTE-Advanced), Beyond Long Term Evolution (LTE-B, LTE-Beyond), the super 3rd generation mobile communication system (SUPER 3G), Advanced International Mobile Telecommunications (IMT-Advanced), the 4th generation mobile communication system (4G), the 5th generation mobile communication system (5G), Future Radio Access (FRA), New Radio Access Technology (New-RAT), New Radio (NR), New radio access (NX), Future generation radio access (FX), Global System for Mobile communications (GSM®), Code Division Multiple Access 3000 (CDMA 3000), Ultra Mobile Broadband (UMB), IEEE 920.11 (Wi-Fi), IEEE 920.16 (WiMAX), IEEE 920.20, Ultra-Wide Band (UWB), Bluetooth® and other appropriate wireless communication methods, and/or next-generation systems that are enhanced based on them.

Terms such as “based on” as used in this specification do not mean “based on only”, unless otherwise specified in other paragraphs. In other words, terms such as “based on” mean both “based on only” and “at least based on.”

Any reference to units with designations such as “first”, “second” and so on as used in this specification does not generally limit the quantity or order of these units. These designations may be used in this specification as a convenient method for distinguishing between two or more units. Therefore, reference to a first unit and a second unit does not imply that only two units may be employed, or that the first unit must precedes the second unit in several ways.

Terms such as “deciding (determining)” as used in this specification may encompass a wide variety of actions. The “deciding (determining)” may regard, for example, calculating, computing, processing, deriving, investigating, looking up (e.g., looking up in a table, a database or other data structures), ascertaining, etc. as performing the “deciding (determining)”. In addition, the “deciding (determining)” may also regard receiving (e.g., receiving information), transmitting (e.g., transmitting information), inputting, outputting, accessing (e.g., accessing data in a memory), etc. as performing the “deciding (determining)”. In addition, the “deciding (determining)” may further regard resolving, selecting, choosing, establishing, comparing, etc. as performing the “deciding (determining)”. That is to say, the “deciding (determining)” may regard certain actions as performing the “deciding (determining)”.

As used herein, terms such as “connected”, “coupled”, or any variation thereof mean any direct or indirect connection or coupling between two or more units, and may include the presence of one or more intermediate units between two units that are “connected” or “coupled” to each other. Coupling or connection between the units may be physical, logical or a combination thereof. For example, “connection” may be replaced with “access.” As used in this specification, two units may be considered as being “connected” or “coupled” to each other by using one or more electrical wires, cables and/or printed electrical connections, and, as a number of non-limiting and non-inclusive examples, by using electromagnetic energy having wavelengths in the radio frequency region, microwave region and/or optical (both visible and invisible) region.

When terms such as “including”, “comprising” and variations thereof are used in this specification or the claims, these terms, similar to the term “having”, are also intended to be inclusive. Furthermore, the term “or” as used in this specification or the claims is not an exclusive or.

Although the present disclosure has been described above in detail, it should be obvious to a person skilled in the art that the present disclosure is by no means limited to the embodiments described in this specification. The present disclosure may be implemented with various modifications and alterations without departing from the spirit and scope of the present disclosure defined by the recitations of the claims. Consequently, the description in this specification is for the purpose of illustration, and does not have any limitative meaning to the present disclosure.

1. A terminal, comprising:
a processing unit configured to perform Orthogonal Frequency Division Multiplexing (OFDM) processing on a first symbol sequence to obtain a second symbol sequence, and perform Faster than Nyquist (FTN) modulation on the second symbol sequence in time domain to obtain a third symbol sequence; and
a transmitting unit configured to transmit the FTN-modulated third symbol sequence.

2. The terminal of claim 1, further comprising:
a receiving unit configured to receive scheduling information, wherein the scheduling information is used to schedule the terminal on a system bandwidth of a communication system,
wherein the transmitting unit transmits the FTN-modulated third symbol sequence according to the scheduling information.

3. The terminal of claim 1, wherein the processing unit is further configured to perform Discrete Fourier Transform (DFT)-based precoding on an initial symbol sequence to obtain the first symbol sequence.

4. The terminal of claim 3, wherein
the OFDM processing at least includes performing subcarrier mapping on the first symbol sequence, and performing Inverse Fast Fourier Transform (IFFT) on the mapped first symbol sequence;
the FTN modulation includes performing up-sampling and pulse shaping on the second symbol sequence, and
a relationship between a sampling factor of the up-sampling and a sampling rate of the pulse shaping is determined according to a relationship between a size of the DFT and a size of the IFFT.

5. The terminal of claim 4, wherein the processing unit performs the subcarrier mapping on the first symbol sequence in a centralized mapping manner.

6. The terminal of claim 4, wherein the processing unit maps the first symbol sequence to a low frequency region to perform the IFFT or the FFT.

7. The terminal of claim, further comprising:
a receiving unit configured to receive information about a compression factor of the FTN modulation, wherein the compression factor indicates the relationship between the sampling factor of the up-sampling and the sampling rate of the pulse shaping.

8. A transmission method, comprising:
performing Orthogonal Frequency Division Multiplexing (OFDM) processing on a first symbol sequence to obtain a second symbol sequence, and performing Faster than Nyquist (FTN) modulation on the second symbol sequence in time domain to obtain a third symbol sequence; and
transmitting the FTN-modulated third symbol sequence.

9. The transmission method of claim 8, wherein the transmission method is performed by a terminal, and the transmission method further comprises:
receiving scheduling information, wherein the scheduling information is used to schedule the terminal on a system bandwidth of a communication system,
wherein the FTN-modulated third symbol sequence is transmitted according to the scheduling information.

10. The transmission method of claim 8, further comprising:
performing Discrete Fourier Transform (DFT)-based precoding on an initial symbol sequence to obtain the first symbol sequence.

11. The terminal of claim 5, wherein the processing unit maps the first symbol sequence to a low frequency region to perform the IFFT or the FFT.

12. The terminal of claim 5, further comprising:
a receiving unit configured to receive information about a compression factor of the FTN modulation, wherein the compression factor indicates the relationship between the sampling factor of the up-sampling and the sampling rate of the pulse shaping.
